(19) United States
(12) Patent Application Publication
(10) Pub. No.: US 2006/0188255 A1
(43) Pub. Date: Aug. 24, 2006

(54) Monitoring wavelength dispersion variation using photon absorption

(75) Inventors: Cechan Tian, Plano, TX (US); Susumu Kinoshita, Plano, TX (US)

Correspondence Address: BAKER BOTTS L.L.P., 2001 ROSS AVENUE, SUITE 600, DALLAS, TX, 75201-2980, US

(73) Assignee: Fujitsu Limited

(21) Appl. No.: 11/062,289

(22) Filed: Feb. 18, 2005

(51) Int. Cl. H04B 10/08

(52) U.S. Cl. 398/33

(57) ABSTRACT

Monitoring wavelength dispersion variation of an optical signal includes receiving the optical signal at a detector. The optical signal comprises photons of different spectrum components. The photons are received at a material of the detector. The material is operable to produce a reaction in response to the arrival of a predetermined number of photons. Reactions produced by the material in response to receiving the plurality of photons are monitored. Whether there is wavelength dispersion variation among the components is established in accordance with the reactions.

### TECHNICAL FIELD

This invention relates generally to the field of optical networks and more specifically to monitoring wavelength dispersion variation using photon absorption.

### BACKGROUND

A communication network may communicate information using optical signals transmitted as light pulses. An optical signal typically includes spectrum components having different wavelengths. The components travel at different speeds, resulting in wavelength dispersion.

Known techniques for compensating for dispersion include passive compensation and tunable compensation. Passive compensation uses fixed dispersion compensating units, such as dispersion compensating fibers, to compensate for dispersion. Passive compensation works adequately for data rates equal to or less than ten gigabits per second (Gbps), but typically not for higher data rates. Tunable compensation detects dispersion variation, and adjusts the signal in accordance with the detected dispersion variation. Typical dispersion variation monitors for monitoring dispersion variation, however, are not suitable in certain situations. It is generally desirable to monitor dispersion variation in certain situations.

### SUMMARY OF THE DISCLOSURE

In accordance with the present invention, disadvantages and problems associated with previous techniques for monitoring wavelength dispersion variation may be reduced or eliminated.

According to one embodiment of the present invention, monitoring wavelength dispersion variation of an optical signal includes receiving the optical signal at a detector. The optical signal comprises photons of different spectrum components. The photons are received at a material of the detector. The material is operable to produce a reaction in response to the arrival of a specific number of photons, such as two photons. Reactions produced by the material in response to receiving the plurality of photons are monitored. Whether there is wavelength dispersion variation among the components is established in accordance with the reactions.

Certain embodiments of the invention may provide one or more technical advantages. A technical advantage of one embodiment may be that a dispersion variation monitor monitors wavelength dispersion variation of a signal in accordance with photon absorption. Photon absorption indicates the shape of the waveform of pulses of the signal. Accordingly, photo absorption may be used to monitor the dispersion variation of the signal.

Another technical advantage of one embodiment may be that an optical fiber with a tapered tip may be used to focus a signal towards a detector of a dispersion variation monitor. Focusing the signal may allow for more photons to arrive at the detector at substantially the same place. Another technical advantage of one embodiment may be that certain components of a dispersion compensation system may be integrated on a semiconductor substrate. Integrating the components may provide for more efficient application of the dispersion compensation system.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating one embodiment of a network that includes a node that has a dispersion variation monitor;

FIG. 2 is a diagram illustrating example photons arriving at one embodiment of a dispersion variation monitor;

FIG. 3 is a block diagram illustrating one embodiment of a dispersion compensation system that may be used at a node of the network of FIG. 1;

FIG. 4 is a block diagram illustrating one embodiment of a fiber and a fiber controller that may be used with the detector system of FIG. 4; and

FIG. 5 is a block diagram illustrating another embodiment of a dispersion compensation system that may be used at a node of the network of FIG. 1.

### DETAILED DESCRIPTION OF THE DRAWINGS

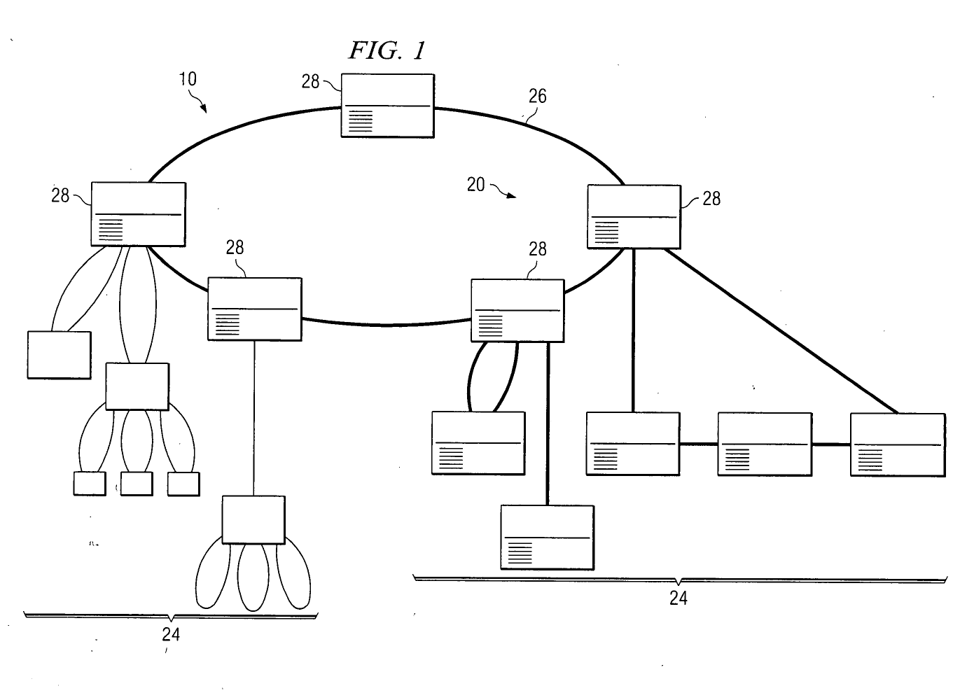

Embodiments of the present invention and its advantages are best understood by referring to FIGS. 1 through 5 of the drawings, like numerals being used for like and corresponding parts of the various drawings.

FIG. 1 is a block diagram illustrating one embodiment of a network 10 that includes a node that has a dispersion variation monitor. According to the embodiment, the dispersion variation monitor monitors wavelength dispersion variation of a signal in accordance with photon absorption. Photon absorption indicates the shape of the waveform of pulses of the signal. Accordingly, photon absorption may be used to monitor dispersion variation of the signal.

According to the illustrated embodiment, network 10 communicates information through signals. A signal may refer to an optical signal transmitted as light pulses comprising photons. An optical signal may have a frequency of approximately 1550 nanometers, and a data rate of, for example, 10, 20, 40, or over 40 gigabits per second. A signal typically includes one or more components. A component may refer to a portion of light having a specific wavelength or wavelength range.

A component with a smaller wavelength travels through a material at a different speed than that of a component with a larger wavelength, so different components travel at different speeds resulting in a spatial separation. Wavelength dispersion refers to the spatial separation resulting from the different speeds. Wavelength dispersion variation refers to changes in wavelength dispersion.

Wavelength dispersion changes the waveform shape of the pulses of a signal. As an example, when a pulse is transmitted, the waveform shape of the pulse may be narrow. As the pulse travels through a medium, the components of the pulse travel at different speeds, and the waveform shape of the pulse becomes wider.

Dispersion tolerance distance decreases in accordance with the square of the data rate. For example, for no return-to-zero (NRZ) modulation, the distance for a 10 gigabits per second signal is approximately 40 kilometers of single-mode fiber (SMF). For 40 gigabits per second, the distance is approximately 2.5 kilometers. Dispersion may cause problems for data rates over 10 gigabits per second, such as rates greater than 40 gigabits per second.

A signal may comprise any suitable signal, for example, a return-to-zero (RZ) signal, a carrier suppressed return-to-zero (CS-RZ) signal, a CS-RZ differential phase shifted keying (DPSK) signal, or a clock signal. A return-to-zero signal and a clock signal include carrier, blue side sub-carrier, red side sub-carrier, and other components.

A signal may communicate information in packets. A packet may comprise a bundle of data organized in a specific way for transmission, and a frame may comprise the payload of one or more packets organized in a specific way for transmission. A packet may carry any suitable information such as voice, data, audio, video, multimedia, other information, or any combination of the preceding. The packets may comprise any suitable multiplexed packets, such time division multiplexed (TDM) packets, communicated using any suitable protocol such as the Ethernet over synchronous optical network (SONET) protocol.

Network 10 includes a ring 20 coupled to access equipment 24 as shown. A ring may refer to a network of communication devices that has a ring topology. According to one embodiment, ring 20 may comprise an optical fiber ring. For example, ring 20 may comprise a resilient packet ring (RPR).

Ring 20 has nodes 28 coupled by fibers 26. A node may refer to a point of a ring at which packets may be communicated to another node. A node 28 may comprise, for example, a dense wavelength division multiplexer (DWDM). A node may include an adaptive dispersion compensation (ADC) device. An adaptive dispersion compensation device monitors dispersion variation, and compensates for the dispersion in accordance with the determination. The dispersion compensation device may use a dispersion compensator, such as a tunable dispersion compensator, to compensate for the dispersion.

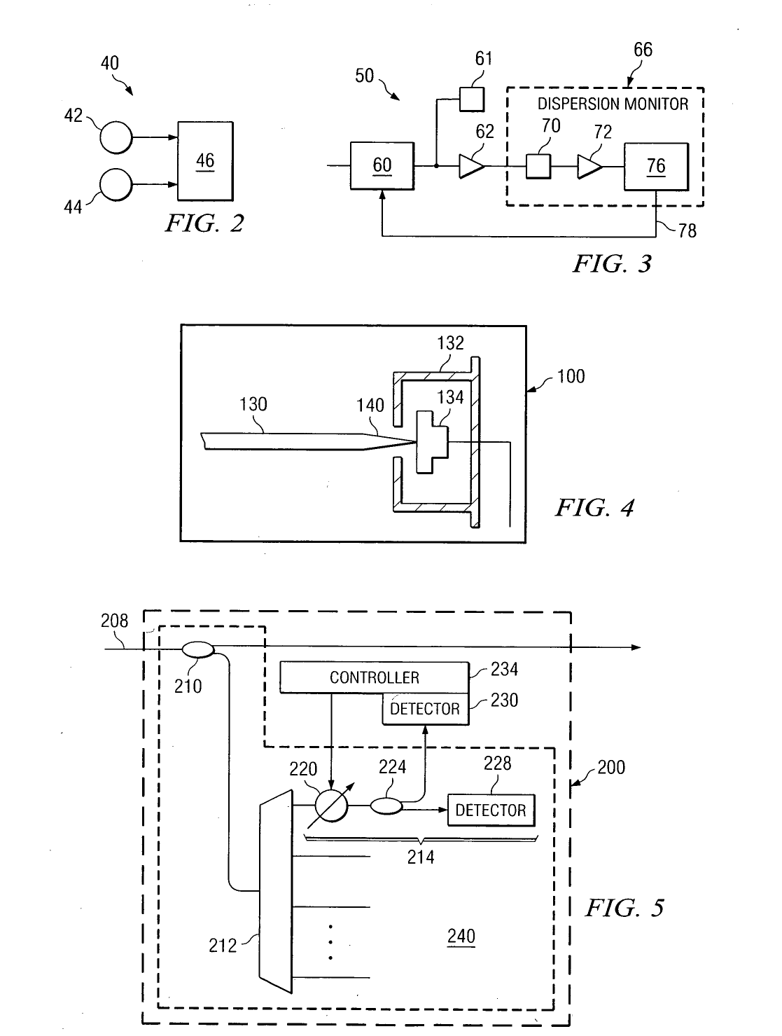

The dispersion compensation device includes a dispersion variation monitor that monitors dispersion variation and instructs the dispersion compensator to compensate for the dispersion. The dispersion variation monitor may monitor wavelength dispersion variation in accordance with photon absorption. A technique for monitoring dispersion variation in accordance with photon absorption is described in more detail with reference to FIG. 2.

FIG. 2 is a diagram 40 illustrating example photons 42 and 44 of an optical signal arriving at one embodiment of a dispersion variation monitor 46. The optical signal comprises a first component and a second component. The first component has a greater wavelength than that of the second component, so the first component travels at a different speed than that of the second component. Accordingly, the signal experiences wavelength dispersion.

The waveform shape of the pulses changes as a result of the wavelength dispersion. Typically, a wider waveform shape indicates more wavelength dispersion, and a narrower waveform shape indicates less wavelength dispersion. A pulse with a narrower waveform shape may include more photons that arrive at monitor 46 at the same time, and a pulse with a wider waveform shape may include fewer photons that arrive at monitor 46 at the same time.

Dispersion variation monitor 46 may include material that may produce a reaction when a predetermined number of photons arrive at substantially the same time at the material. According to the illustrated embodiment, the material reacts when two photons 42 and 44 arrive at the same time. More photons arriving at the material increases the probability that the predetermined number of photons arrive at substantially the same time, thus increasing the number of reactions. Since a pulse with a narrower waveform includes more photons that arrive at the material at the same time, a narrower waveform pulse may generate more reactions than a wider waveform pulse.

Dispersion variation monitor 46 may monitor the reactions occurring at the material. A change in the number of reactions may indicate dispersion variation. Example dispersion variation monitors are described in more detail with reference to FIGS. 3 through 5.

Referring back to FIG. 1, fibers 26 may refer to any suitable fiber operable to transmit a signal. According to one embodiment, a fiber 26 may represent an optical fiber. An optical fiber typically comprises a cable made of silica glass or plastic. The cable may have an outer cladding material around an inner core. The inner core may have a slightly higher index of refraction than the outer cladding material. The refractive characteristics of the fiber operate to retain a light signal inside of the fiber.

Access equipment 24 may include any suitable device operable to communicate with nodes 28 of ring 20. Examples of access equipment 24 include access gateways, endpoints, softswitch servers, trunk gateways, networks, access service providers, Internet service providers, or other device operable to communicate with nodes 28 of ring 20.

Modifications, additions, or omissions may be made to network 10 without departing from the scope of the invention. The components of network 10 may be integrated or separated according to particular needs. Moreover, the operations of network 10 may be performed by more, fewer, or other devices. Additionally, operations of network 10 may be performed using any suitable logic. Logic may refer to hardware, software, or any combination of hardware and software. As used in this document, “each” refers to each member of a set or each member of a subset of a set.

FIG. 3 is a block diagram illustrating one embodiment of a dispersion compensation system 50 that may be used at node 28 of network 10 of FIG. 1. According to the illustrated embodiment, dispersion compensation system 50 includes a dispersion compensator 60, an optical receiver 61, an amplifier 62, and a dispersion variation monitor 66 coupled as shown.

In operation, dispersion compensator 60 receives an optical signal, and send the signal to optical receiver 61 and amplifier 62. Amplifier 62 amplifies the optical signal. Dispersion variation monitor 66 monitors dispersion variation, and instructs dispersion compensator 60 to compensate for the dispersion in accordance with the dispersion variation. For an RZ signal, the monitoring accuracy may be greater than approximately 50 picoseconds per nanometer at 10 gigabits per second.

Dispersion compensator 60 compensates for dispersion of an optical signal, and may comprise, for example, a tunable dispersion compensator (TDC). According to one embodiment, dispersion compensator 60 receives an optical signal, and focuses the signal onto a diffraction grating. The grating separates the channels of the signal and spreads out the components of each channel. The components are then directed towards a phase adjuster that adjusts the phase of the components. As an example, a phase adjuster may comprise a microelectromechanical system (MEMS) that includes micromirrors. Each micromirror applies a phase adjustment to a component. Adjusted components are then combined at the diffraction grating.

Amplifier 62 amplifies the optical signal. Amplifier 62 may comprise an optical repeater that amplifies an optical signal without opto-electrical or electro-optical conversion. Amplifier 62 may comprise an optical fiber doped with a rare-earth element. When a signal passes through the fiber, external energy is applied to excite the atoms of the doped portion of the optical fiber, which increases the intensity of the optical signal. As an example, amplifier 62 may comprise an erbium-doped fiber amplifier (EDFA).

Dispersion variation monitor 66 monitors dispersion variation and instructs dispersion compensator 60 to compensate for the dispersion in accordance with the variation. According to the illustrated embodiment, dispersion variation monitor 66 includes a detector 70, an amplifier 72, and a voltage monitor 76.

Detector 70 monitors dispersion variation of an optical signal. Detector 70 may comprise a material that may produce a reaction when a predetermined number of photons arrive at substantially the same time at substantially the same place of the material. For example, the material may release an electron when a predetermined number of photons arrive at substantially the same time at substantially the same place of the material. More photons arriving at the material increases the probability that the material will produce reactions. Substantially the same place may refer to the area in which the number of photons may arrive to produce the reaction. Substantially the same time may refer to the time period in which the number of photons may arrive to produce the reaction.

The material may be selected to respond to a predetermined number of photons. According to one embodiment, the material may be selected such that the band gap energy E_{g} of the material may react to a number n of photons having photon energy hν. To detect n photons, a material with a band gap energy E_{g} may be selected according to Equation (1):
(n−1)hν≦E_{g}≦nhν (1)
For example, a material with an energy E_{g} may be selected according to Equation (2) to detect two photons:
hν≦E_{g}≦2hν (2)

According to one embodiment, detector 70 may comprise a photodiode such as an avalanche photodiode. An avalanche photodiode comprises a semiconductor material such as silicon. Silicon may release an electron when two photons arrive at substantially the same time at substantially the same place. That is, two photons may generate one electron-hole pair. The photon current is proportional to the square of the input power.

An avalanche photodiode internally amplifies a photocurrent by an avalanche process. When incident photons come into contact with an active region of the semiconductor material, electrons may be generated. A voltage may be applied across the active region to accelerate the electrons as they move through the active region. As the electrons collide with electrons of the semiconductor material, more electrons become part of the photocurrent, resulting in avalanche multiplication. Avalanche multiplication continues until the electrons move out of the active region.

Amplifier 72 amplifies the output, such as an electrical current, received from detector 70. Amplifier 72 may comprise a low-frequency electrical amplifier. Voltage monitor 76 monitors the voltage of the amplified current. The voltage changes even if the signal has the same optical power. A change in voltage indicates wavelength dispersion variation. Voltage monitor 76 instructs dispersion compensator 60 through electrical feedback 78 to compensate for the dispersion in accordance with the monitored dispersion variation.

Modifications, additions, or omissions may be made to dispersion compensation system 50 without departing from the scope of the invention. The components of dispersion compensation system 50 may be integrated or separated according to particular needs. Moreover, the operations of dispersion compensation system 50 may be performed by more, fewer, or other components.

FIG. 4 is a block diagram illustrating one embodiment of a detector system 100 that may be used with dispersion variation monitor 66 of FIG. 3. According to the illustrated embodiment, detector system 100 includes a fiber 130 and a detector 132 with detector material 134 arranged as shown. Detector 132 and detector material 134 may be substantially similar to detector 70 of FIG. 2.

Fiber 130 may comprise an optical fiber operable to focus the signal towards detector material 134. According to the illustrated embodiment, fiber 130 has a tip 140 operable to focus the optical signal. According to one embodiment, tip 140 may be tapered to focus the components. The slope of the taper may be approximately 8 micrometers per 10 micrometers.

Fiber 130 focuses the signal on a focusing area. A focusing area may refer to the particular area of detector material 134 that receives the photons of the signal. The photon current is inversely proportional to the focusing area. Accordingly, decreasing the focusing area increases the photon current. The focusing area may be approximately 2.5 microns in diameter.

Modifications, additions, or omissions may be made to detector system 100 without departing from the scope of the invention. The components of detector system 100 may be integrated or separated according to particular needs. Moreover, the operations of detector system 100 may be performed by more, fewer, or other components.

FIG. 5 is a block diagram illustrating another embodiment of a dispersion compensation system 200 that may be used at node 28 of network 10 of FIG. 1. According to the illustrated embodiment, dispersion compensation system 200 includes an input 208, a splitter 210, a demultiplexer 212, a wave monitor 214, a photodiode 230, and a controller 234.

Input 208 receives an optical signal. Splitter 210 splits the optical signal into a monitored signal and a pass-through signal. Pass-through signal passes through dispersion variation monitor 200. Monitored signal is transmitted to demultiplexer 212. Demultiplexer 212 operates as a wave separator and demultiplexes the signal into individual waves. According to another embodiment, a filter may be used as a wave separator to select individual waves.

Wave monitor 214 receives an individual wave from demultiplexer 212, and monitors the wave for dispersion variation. According to the illustrated embodiment, wave monitor 214 includes an attenuator 220, a coupler 224, and a detector 228. Attenuator 220 attenuates the wave received from demultiplexer 212, and keeps the optical power to the dispersion monitor constant. Attenuator 220 may comprise a variable optical attenuator. Coupler 224 directs the wave to detector 228 and detector 230. Detector 228 monitors dispersion variation of the wave. Detector 228 may be substantially similar to detector 70 of FIG. 2. Detector 230 detects the optical power and provides the feedback signal for attenuator 220 to maintain a constant optical power. Controller 232 receives output from detector 230, and instructs attenuator 220 to attenuate a wave.

According to one embodiment, certain components of dispersion compensation system 200 may be provided at an integrated portion 240. As an example, certain components may be formed from layers disposed outwardly from a semiconductor substrate such as a silicon substrate. According to the illustrated embodiment, integrated portion 240 may comprise splitter 210, demultiplexer 212, and wave monitor 214. Integrated portion 240, however, may include any combination of any of components of dispersion variation monitor 200.

Modifications, additions, or omissions may be made to dispersion compensation system 200 without departing from the scope of the invention. The components of dispersion compensation system 200 may be integrated or separated according to particular needs. Moreover, the operations of dispersion compensation system 200 may be performed by more, fewer, or other components.

Certain embodiments of the invention may provide one or more technical advantages. A technical advantage of one embodiment may be that a dispersion variation monitor monitors wavelength dispersion variation of a signal in accordance with photon absorption. Photon absorption indicates the shape of the waveform of pulses of the signal. Accordingly, photon absorption may be used to monitor the dispersion variation of the signal.

Another technical advantage of one embodiment may be that an optical fiber with a tapered tip may be used to focus a signal towards a detector of a dispersion variation monitor. Focusing the signal may allow for more photons to arrive at the detector at substantially the same place. Another technical advantage of one embodiment may be that certain components of a dispersion compensation system may be integrated on a semiconductor substrate. Integrating the components may provide for more efficient application of the dispersion compensation system.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A method for monitoring wavelength dispersion variation of an optical signal, comprising:
receiving at a detector an optical signal transmitted as a plurality of light pulses, the optical signal comprising a plurality of components, the optical signal comprising a plurality of photons;
receiving the plurality of photons at a material of the detector, the material operable to produce a reaction in response to the arrival of a predetermined number of photons of the plurality of photons;
monitoring a plurality of reactions produced by the material in response to receiving the plurality of photons; and
establishing whether there is wavelength dispersion variation among the plurality of components in accordance with the reactions.

2. The method of claim 1, wherein the material has a band gap energy corresponding to a photon energy of the predetermined number of photons.

3. The method of claim 1, establishing whether there is wavelength dispersion variation among the plurality of components in accordance with the reactions further comprises:
determining if there is a change in the reactions produced by the material; and
establishing that there is wavelength dispersion variation if there is a change.

4. The method of claim 1, further comprising:
focusing the optical signal towards the material using an optical fiber having a tapered end.

5. The method of claim 1, wherein the material is operable to:
generate an electron hole-pair if the predetermined number of photons are received at substantially the same time; and
fail to generate the electron hole-pair if the predetermined number of photons are not received at substantially the same time.

6. The method of claim 1, wherein:
the material is operable to generate a current in response to the plurality of reactions; and
monitoring the reactions produced by the material in response to the plurality of reactions further comprises measuring the current.

7. A system for monitoring wavelength dispersion variation of an optical signal, comprising:
a detector operable to receive an optical signal transmitted as a plurality of light pulses, the optical signal comprising a plurality of components, the optical signal comprising a plurality of photons, the detector comprising a material operable to:
receive the plurality of photons; and
produce a reaction in response to the arrival of a predetermined number of photons of the plurality of photons; and
a monitor coupled to the detector and operable to:
monitor a plurality of reactions produced by the material in response to receiving the plurality of photons; and
establish whether there is wavelength dispersion variation among the plurality of components in accordance with the reactions.

8. The system of claim 7, wherein the material has a band gap energy corresponding to a photon energy of the predetermined number of photons.

9. The system of claim 7, the monitor operable to establish whether there is wavelength dispersion variation among the plurality of components in accordance with the reactions by:
determining if there is a change in the reactions produced by the material; and
establishing that there is wavelength dispersion variation if there is a change.

10. The system of claim 7, further comprising:
an optical fiber having a tapered end and operable to focus the optical signal towards the material.

11. The system of claim 7, wherein the material is operable to:
generate an electron hole-pair if the predetermined number of photons are received at substantially the same time; and
fail to generate the electron hole-pair if the predetermined number of photons are not received at substantially the same time.

12. The system of claim 7, wherein:
the material is operable to generate a current in response to the plurality of reactions; and
the monitor is operable to monitor the reactions produced by the material in response to the plurality of reactions by measuring the current.

13. An integrated circuit for monitoring wavelength dispersion variation of an optical signal, comprising:
a wave separator operable to:
receive an optical signal transmitted as a plurality of light waves, the optical signal comprising a plurality of components, a light wave comprising a plurality of photons; and
separate the plurality of light waves; and
a plurality of wave monitors coupled to the wave separator, a wave monitor comprising:
a detector operable to receive a light wave of the plurality of light waves, the detector comprising a material operable to:
receive the plurality of photons; and
produce a reaction in response to the arrival of a predetermined number of photons of the plurality of photons; and
a monitor coupled to the detector and operable to:
monitor a plurality of reactions produced by the material in response to receiving the plurality of photons; and
establish whether there is wavelength dispersion variation among the plurality of components in accordance with the reactions.

14. The integrated circuit of claim 13, wherein the material has a band gap energy corresponding to a photon energy of the predetermined number of photons.

15. The integrated circuit of claim 13, the monitor operable to establish whether there is wavelength dispersion variation among the plurality of components in accordance with the reactions by:
determining if there is a change in the reactions produced by the material; and
establishing that there is wavelength dispersion variation if there is a change.

16. The integrated circuit of claim 13, further comprising:
an optical fiber having a tapered end and operable to focus the optical signal towards the material.

17. The integrated circuit of claim 13, wherein the material is operable to:
generate an electron hole-pair if the predetermined number of photons are received at substantially the same time; and
fail to generate the electron hole-pair if the predetermined number of photons are not received at substantially the same time.

18. The integrated circuit of claim 13, wherein:
the material is operable to generate a current in response to the plurality of reactions; and
the monitor is operable to monitor the reactions produced by the material in response to the plurality of reactions by measuring the current.

19. The integrated circuit of claim 13, wherein the wave monitor further comprises an optical attenuator operable to:
receive a light wave from the wave selector;
attenuate the received light wave; and
transmit the light wave to the detector.

20. The integrated circuit of claim 13, further comprising a splitter operable to:
receive a signal;
split the signal to yield the optical signal; and
transmit the optical signal to the wave separator.

21. A system for monitoring wavelength dispersion variation of an optical signal, comprising:
means for receiving at a detector an optical signal transmitted as a plurality of light pulses, the optical signal comprising a plurality of components, the optical signal comprising a plurality of photons;
means for receiving the plurality of photons at a material of the detector, the material operable to produce a reaction in response to the arrival of a predetermined number of photons of the plurality of photons;
means for monitoring a plurality of reactions produced by the material in response to receiving the plurality of photons; and
means for establishing whether there is wavelength dispersion variation among the plurality of components in accordance with the reactions.

22. A system for monitoring wavelength dispersion variation of an optical signal, comprising:
a detector operable to receive an optical signal transmitted as a plurality of light pulses, the optical signal comprising a plurality of components, the optical signal comprising a plurality of photons, the detector comprising:
an optical fiber having a tapered end and operable to focus the optical signal; and
a material operable to:
receive the plurality of photons;
produce a reaction in response to the arrival of a predetermined number of photons of the plurality of photons; and
generate a current in response to the plurality of reactions, the material having a band gap energy corresponding to a photon energy of the predetermined number of photons, the material operable to:
generate an electron hole-pair if the predetermined number of photons are received at substantially the same time; and
fail to generate the electron hole-pair if the predetermined number of photons are not received at substantially the same time; and
a monitor coupled to the detector and operable to:
monitor a plurality of reactions produced by the material in response to receiving the plurality of photons by measuring the current; and
establish whether there is wavelength dispersion variation among the plurality of components in accordance with the reactions by:
determining if there is a change in the reactions produced by the material; and
establishing that there is wavelength dispersion variation if there is a change.
